(19) United States
(12) Patent Application Publication
(10) Pub. No.: US 2004/0068750 A1
(43) Pub. Date: Apr. 8, 2004

(54) Methods and systems for multimedia data synchronization and multilevel network communication

(76) Inventor: Shalong Maa, Arlington, TX (US)

Correspondence Address: SHALONG MAA, P.O. BOX 117015, CARROLLTON, TX, 75011, US

(21) Appl. No.: 09/919,187

(22) Filed: Jul. 30, 2001

Related U.S. Application Data
(60) Provisional application No. 60/221,991, filed on Jul. 31, 2000.

(51) Int. Cl. H04N 7/173; H04N 7/16

(52) U.S. Cl. 725/113; 725/110; 725/112; 725/109; 725/135

(57) ABSTRACT

Disclosed herein are methods and systems for causing transmission of Web contents from a Web site to a home client computer in synchronization with the broadcasting of a TV program. Two systems for implementing said synchronization are provided including, (1) Server-Side Synchronization in which said synchronization is performed at the server sides: the TV broadcasting system is provided with a synchronization system for sending synchronization signals to the TV station's Web site; in response thereto, said Web site will send the Web contents or data associated with the TV program to the clients; and (2) Client Remote-Control Synchronization in which said computer is provided with application system for receiving and responding to signals transmitted from a conventional TV/VCR remote control device such that, when the TV channel is switched by said remote control device, the Web site accessed by the home computer will also be switched.

The present Application Claims the benefit of U.S. Provisional Patent Application No. 60/221,991, filed on Jul. 31, 2000, entitled “Methods and Systems for Building Multi-level Online Community and for Network Data Signal Synchronization”

### FIELD OF THE INTENTION

The present invention relates generally to interactive network communication method and system and multimedia data synchronization system, and more particularly, to multilevel network communication methods and system for populating or propagating information among the network users, and to method and system for synchronizing multimedia data transmitted from two or more separate multimedia service providers, such as Internet Web server and TV broadcast unit or the like, to a client-user system.

### BACKGROUND OF THE INTENTION

With the increasing popularity of interactive electronic networks such as the Internet and the World Wide Web, it has become common for advertisers to use electronic means such as E-Mail, Instant Messaging system and Web site to reach their target customer group. For the purposes of providing the consumer public with new and better services and improving advertising effectiveness, there have been immense efforts to integrate such interactive network media with the conventional electronic media such as television to provide the consumers with combined interactive multimedia contents and services, such as the so-called interactive TV or Web TV services or the like currently available in the market.

It is well known that Email marketing has the advantages of convenience and low cost. However, one problem with the existing Email marketing model is that it is not effective. Email marketing's convenience and low cost have resulted in its overwhelming usage by all online advertisers. As a result, the Internet users do not always trust all the Email advertising information they receive. Furthermore, virtually every Internet user receives many unwanted E-mail every day, which has substantially diminishes the effectiveness of such electronic marketing means.

Web site advertising such as banners on top or bottom of a Web page or pop-up advertisement windows or the like has been employed by many online content providers and online merchants. One problem with such advertising model is that the Web site advertisements are often ignored by the online users. Furthermore, it is known that most of the Web users do not spend much time online, and thus, do not have enough time or patient to explore all the contents, features or Web pages provided by the Web site, and that online content/service providers do not have enough resource for training their users to use their services at all. In regarding E-commerce, it is known that the consumer public's traditional buying behavior, i.e., supermarket shopping, has not been substantially changed by online merchants' discount sales and high-cost advertisements and the intense news coverage by the media.

Thus, it would be desirable to provide novel electronic marketing means and business methods of the type directed to changing the consumer public's buying behavior and improving the effectiveness of E-mail marketing. It would also be desirable to improve the current Web site advertising model such that the users there of would be more interested in the advertisements provided thereon.

In regarding integrating interactive communication networks such as the Internet with the traditional electronic media such as television for providing integrated or synchronized interactive multimedia contents and services, it is known that almost all of the existing service providers thereof focus on client-side integration. For examples, the existing Interactive TV or Web TV services currently available in the market employ the so-called set-top box or the like at the client side to provide such integration so that a home audience can access a Web site via said set-top box, and interact with and view the Web sit content such as sending E-mail through a television set; The “:CueTV” service in the market, provided by Digital Convergence Corp. (www.crq.com), requires a software system to be installed at the client-side computer to analyze signals transmitted from a TV set via a connection cable so as to provide synchronized TV and Web contents to the audience.

A number of shortcomings, however, exist in the aforementioned client-side integration system. First of all, it often requires expensive hardware and software system or unit, such as said set-top box, to be installed and operated at the consumers' client-side TV/computer systems. Thus, the service provider thereof will incur substantial expenses to manufacture, promote and distribute the integration units. Another problem with the prior art client-side integration system is that it is impossible to employ such system to provide the users thereof with synchronized TV-Internet streaming media or data, such as a TV program being synchronized with streaming data transmitted from a Web site to the Web browser of a client-user computer.

Thus, it would be desirable to provide novel multimedia streaming data synchronization system and method of the type employing synchronization mechanism at the server sides thereof so as to enable synchronization of streaming data and/or media transmitted from two or more separate media systems.

### SUMMARY OF THE INVENTION

Accordingly, an object of the present invention is to provide novel electronic marketing means and business methods of the type directed to changing the consumer public's buying behavior and improving the effectiveness of E-mail marketing, by creating multi-level online user network, having intrinsic organic growth mechanisms, such that different levels of said user network are inter-related by each user's personal relationship with his/her friends or relatives.

Another object of the present invention is to provide methods and systems for causing transmission of electronic streaming media or data provided by a Web site in synchronization with transmission of a TV program provided by a TV broadcasting station in such a manner that, there is a concurrent relation between the TV program received by a user's home TV and the Web contents or data received by the user's Internet computer. A further object of the present invention is to provide convenient remote TV and Web browser operation and synchronization system for home users.

To achieve the foregoing and other objects of the present inventions, there are provided method and system for creating multi-level online user network, methods and systems for multimedia streaming data synchronization, and remote multimedia operation and synchronization system for home user.

According to one aspect of the present invention, a Web site is provided with application systems for creating multi-level user network for online users via pre-registration processes. When a new user finishes his/her membership registration process, or an existing member log in or access the Web site thereof, he/she will be requested by the Web site to conduct pre-registration for his/her friends or relatives, so as to create the next level network members, and thereafter, contact said friends or relatives recommending thereto said registration and the products or services provided on said Web site. Within the multi-level user network, a new member registered through said pre-registration and recommendation will be the next level user who may, in turn, create his/her own lower level sub-network through said recommendation and pre-registration process. Thus, said multi-level network is provided with an intrinsic organic growth mechanisms based on each user's personal relationship with his/her friends and relatives, through which an advertising or other message can be populated effectively among the users with minimum resource or marketing expenses.

According to another aspect of the present invention, a synchronization system is provided for installation on a Web site system and a TV broadcast system such that the transmission of streaming data or media from the Web site to a home user's Web browser and/or home computer are synchronized, in a predefined manner, with a TV program transmitted from the TV broadcast unit to the user's home TV.

The foregoing is intended to be merely a summary and not to limit the scope of the specification. The features of the present invention, which are believed to be novel, are set forth with particularity in the annexed claims. The invention, however, together with further objects and advantages thereof, may best be appreciated by reference to the following detailed description taken in conjunction with the drawings.

### BRIEF DESCRIPTION OF THE DRAWINGS

FIG. 1 is a schematic illustration of the conventional client-server Internet architecture.

FIG. 2 is a flow chart showing the flow of an application program running on a Web site for creating multilevel online user network in accordance with one aspect of the present inventions.

FIG. 3 is a schematic representation of a multi-level online user network created by the application program of FIG. 2

FIG. 4 is a block diagram illustrating the TV/Web site data signal transmission and synchronization system and user operation control system in accordance with another aspect of the present inventions.

FIG. 5 is a block diagram depicting the detailed operating processes of the user operation control system of FIG. 4

FIG. 6 schematically illustrates the transmission of a data stream from an Internet Web site in synchronization with transmission of a TV program signal stream according to the present inventions.

FIG. 7 is a flow diagram showing the flow of an application process running on a Web site server, in accordance with another aspect of the present inventions, for selecting Web site advertisement and ad display rotation based on the text content thereon.

### DETAILED DESCRIPTION OF THE INTENTION

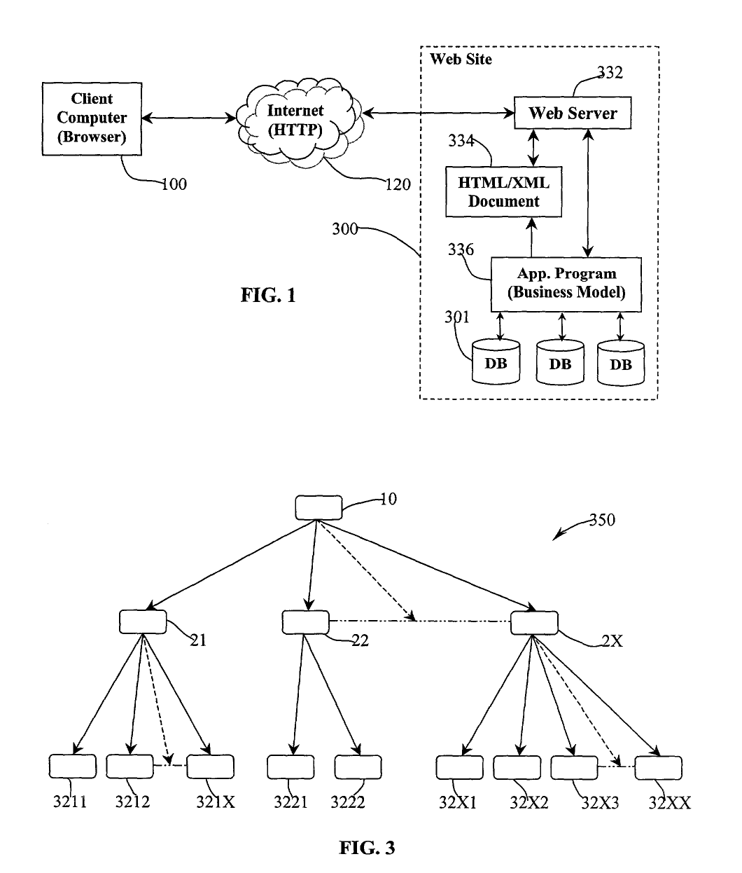

Referring to FIGS. 1-7, there are shown methods and systems for multimedia data synchronization and multilevel network communication embodying the concepts of the present inventions. While the present inventions are susceptible to embodiments in various forms, there are in the drawings and will hereinafter be described presently preferred embodiments, with the understanding that the present disclosure is to be considered as exemplifications of the inventions, and does not limit the inventions to the specific embodiments illustrated. In some instances, for the purposes of explanation and not for limitation, specific numbers, systems, processes, or operation steps, etc., may be set forth in order to provide a thorough understanding of the present inventions. In other instances, detailed descriptions of well-known electronic components or computing network or systems, mechanical elements, and software/hardware systems or processes are omitted so as to not obscure the depiction of the present invention with unnecessary details.

As shown in FIG. 1, a conventional client-server interactive network architecture includes an online end user's client computer or Web browser 100 connected to a remote Web site 300 via an interactive electronic computing/communication network 120 such as the Internet. Typically, the Web site 300 is operated by a business entity or an organization. The remote client 100 may be of any type of computing device that allows a user to interactively browse Web sites on the Internet 120 via a Web browser. The Web site 300 usually includes a Web server processing system 332 for serving or providing a Web document 334 requested by the client computer 100. The Web site 300 may also provide various other functionalities for allowing the users of the client computer 100 to interact with the Web site and the Internet, such as sending E-mails, viewing a video clip, or requesting information from or sending personal information or requests to the Web site 300. In a standard request-response process for viewing a graphical Web page 334 by the client 100, the client system 100 specifies the URL or IP address of the Web page 334 in a request, which is forwarded to the corresponding Web server 332 supporting the Web page 334. In response thereto, the Web server 332 sends the requested Web page 334 to the client 100. Currently, the primary standard protocol for allowing applications to locate and acquire Web documents is HTTP, as shown in FIG. 1, although any other type of feasible data transfer protocol may also be employed on the interactive communication network 120.

Typically, the Web site 300 also includes application or programming system 336 and database system 301 for implementing said business entity's various business applications, such as those described in the present specification hereinbelow. The Web document or content 334 served on or provided by the Web site 300 and/or requested by the client 100 may be a client-independent or static document or streaming media, such as the aforementioned graphical Web page, or a audio/video clip, in HTML, XML, Windows Media Player, or RealPlayer format, or in any other standard or commonly used format. Said static or client-independent Web contents are normally stored directly in the Web server 332's memory means or in the Web site 300's database storage system 301. For example, an electronic news Web page or a video/audio clip, which is to be displayed identically by every client user's Web browser or media player, may be stored in the database 301 and be directly processed and sent to the client 100 by the Web server 332 through the Internet 120.

The Web content 334 transmitted to and/or requested by the client computer 100 may also be Web pages or streaming data or media dynamically created by the application program 336, such as those described in the ensuing sections of the present specification. The database system 301 provides storage means for the Web site 300 and the application programming system 336 so as to implement said business entity's business applications. For example, the Web page 334 to be displayed by the client browser 100 may be created by the application program 336 based on the client user's certain personal information, such as the user's name, address, membership status, etc. stored in the database system 301.

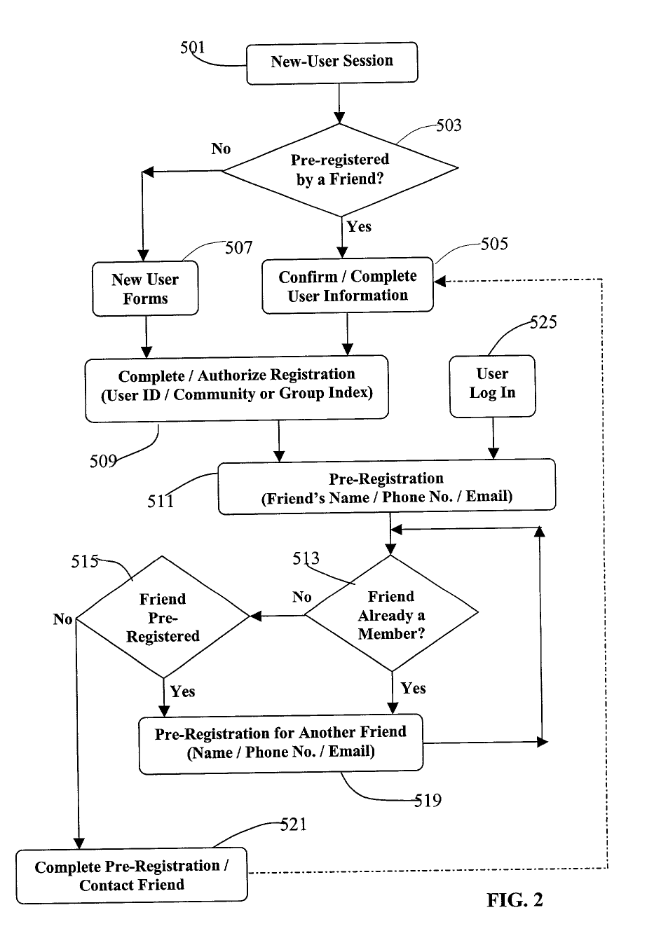

Referring now to FIGS. 2-3, there are shown methods and systems for creating an exemplary multilevel online user network 350 according to the present inventions. The user network 350 shown in FIG. 3 includes 3 network levels, i.e., the first level, comprising the network member 10, the second level, comprising network members 21, 22, . . . , and 2X, and the third level, including network members 3211, 3212, . . . , 321X, 3221,3222, 32X1, 32X2, 32X3, . . . , and 32XX. One skilled in the art would understand that an actual multilevel online user network of the present invention may be larger or smaller than shown in FIG. 3, and may have much more, or sometimes less, than three (3) network levels, and that the Web site 300 may support more than one independent or separate multilevel user networks. In FIG. 3, a new lower level member of the user network 350 is developed or created based on an existing member's personal relationship with his/her friends or relatives. Therefore, different levels of the user network 350 are inter-related by the respective network users' personal relationships. Thus, it is appreciated that the multilevel online user network 350 is provided with intrinsic network growth mechanism for recruiting new users to use services provided by the Web site 300.

In FIG. 3, the Web user 10 is the user network 350's first and highest-level member, who may acknowledge the Web site 300 from any of the Web site owner's advertisements. In order for recruiting new members, after the member 10 finishes his/her registration process, or when the member 10 loges into his/her account, the Web pages or contents sent from the Web site 300 to the member 10's client browser will provide means, such as information request forms, for the member 10 to submit, to the Web site 300, brief personal information about his/her friends or relatives. Thereafter, the member 10 may be requested by the Web site 300 to contact said friends or relatives in person. The purpose hereof is to have every members of the user network 350, such as the members 10 and 2X in FIG. 3, to recruit new members and develop the respective next or lower level sub-networks thereunder by conducting online pre-membership-registration process for their friends and/or relatives. A new member's actual or final registration or membership confirmation process may have to be completed by said new member. In FIG. 3, the first or highest network level consists of member 10; the second or next lower level network members developed or recruited by and thus situated under the member 10 includes the members 21, 22, . . . , and 2X, who may be the member 10's actual friends or relatives in real life or the member 10's online virtual friends. Each of these lower level members 21, 22, . . . , and 2X may in turn recruit new members and thus develops his/her own lower level sub-network by conducting online pre-registration processes for his/her friends or relatives, as described above. As shown in FIG. 3, the third level network members developed or recruited by and thus residing under the member 21 include members 3211, 3212, . . . , and 321X; the third level network members developed or recruited by, and thus situated under, the member 22 include members 3221 and 3222; the third level network members developed/recruited by and situated under the member 2X include members 32X1 and 32X2, 32X3, . . . , and 32XX.

Personal information submitted by each member of the user network 350 about a friend or relative of him or her during said pre-registration processes may include said friend/relative's name, phone number, correspondence or E-mail address, etc. Such pre-registration information may be subject to the respective lower-level new member's confirmation during the actual registration process. The Web site 300 may set forth various rules to facilitate each of the user network member's recruiting, so as to develop or expand said member's lower level sub-network thereunder, or to encourage every member of the user network 350 to use the services provided by the Web site 300. For examples, (1) within a set period of time, a network member may be required to use the services provided by the Web site 300, such as online shopping or auction or the like, at least once to qualify for any reward or credit provided by the Web site; (2) a network member may be required to contact his/her friends or relatives in person for introducing products or services provided the Web site 300 during or after the aforementioned pre-registration processes; (3) each user being pre-registered by his/her friend or relative may be required to complete the registration and start using the services provided by the Web site 300 within a set period of time; (4) a user may not be pre-registered by a friend and become a lower-level network member thereunder if he/she is already a member of the user network 350, or has been pre-registered by another friend; etc. All these and other rules can be implemented by the Web site 300's application programming system 336 (FIG. 1), and be presented as dynamically created Web pages to be displayed by the respective client user's Web browser. Thus, each member of the user network 350 will plays a rooting or seeding role for planting and expanding his/her lower level sub-network thereunder, and for populating information, such as an advertising message regarding the services provided by the Web site 300, within the multilevel user network 350.

One skilled in the art would understand that, within the user network 350, the lower-level sub-network under each member may includes many lower levels, and that each said lower level may be comprised of many members. The Web site 300 may offers various rewards for encouraging every member of the multilevel online user network 350 to recruit new members and to use all services provided by the Web site. It is preferred that said rewards are associated with the inter-level correlations between adjacent network levels of the multilevel user network 350. For example, the Web site 300 may be used as an online merchant or E-commerce Web site; and, the user network 350 may therefore be created or developed as an online shopping network or community. In this case, the aforementioned reward offered by the Web site 300 to the member 10 could be financial reward, such as cash and/or store credit, for certain percentage of purchases ordered on the Web site 300 by any of the member 10's lower-level sub-network members, such as by the members 21, 22, . . . , or 2X, and/or, by the members 3211, 321X, . . . , or 32XX, etc. Said reward may also be based on the community 350's overall usage of services provided by the Web site 300 within a set period of time.

One skilled in the art would also understand that all information relating to each member of the multilevel online user network 350 may be stored in the commonly used database system 301 of the Web site 300 (FIG. 1). For example, information about the member 2X stored in the database 301 may include: 1) general personal information about the member 2X, such as his/her name, user log-in name/password, age, phone number, etc.; 2) information about the member 2X's higher-level members, such as information about the member 10, the member 2X's recruiter; 3) information about the member 2X's lower-level sub-network members, such as information about the member 32X1, 32X2, 32X3, etc.; 4) information about the entire community 350, such as total number of members, member names, and community performance or activities as to average usage of services provided by the Web site 300, etc. Such information shall be stored in the database 301 as appropriate relational database tables, and may be sent to the member 2X's Web browser as dynamically created Web pages if requested.

Referring now to FIG. 2, there is shown the flow of an application program to be implemented on the Web site 300's application system 336 (FIG. 1) for creating multilevel online user network 350 of FIG. 3. As shown in FIG. 2, the application process starts with step 501 when a new user client access the Web site 300, and thus cause the Web site 300 to create a new-user session. The Web site will then, at the next step 503, determine whether the new user has been pre-registered by any of his/her friends or relatives. If so, at the following step 505, said new user will be requested by the Web site to confirm the user information on record and to complete all required user information; If said new user has not been pre-registered, the Web site will sent new-user registration forms to the new user's client computer at step 507. Thereafter at step 509, the final step of the registration, the Web site will request the new user to complete and authorize said registration to become a new member of the user network, and provide the new member with a user ID and/or a multilevel network index. The multilevel network index assigned to each new member may be based on the new member's position in the network, such as how many higher network levels the entire user network has above said new member, or on development history from the starting point of the user network tree to the end or leaf position of said new member. After said new user finishes the registration processes, the Web site will ask the new user to conduct pre-registration for one of his/her friends at step 511, by requesting brief personal information about that friend such as said friend's name, phone number, E-mail address, etc. It is understood that the application process of FIG. 2 may also start with step 525 when an existing member log into his/her user account, followed by the step 511 described above. The pre-registration processes starting at and following the step 511 are the same for all new and existing members. At the next two steps 513 and 515, the Web site will determine whether said friend being pre-registered by the network member at step 511 is already a member or has already been pre-registered. If said friend being pre-registered at step 511 is already a member or has already been pre-registered, then at step 519, the Web site will request the network member of the current session to conduct pre-registration for another friend, and then repeat the step 513 and those thereafter; Otherwise, if said friend being pre-registered at step 511 is not a member yet and has not been pre-registered, the Web site will, at step 521, request said network member of the current session to complete the pre-registration and then contact said friend being pre-registered. The Web site may then send a custom-built Web page to the pre-registered user via E-mail to have the user confirm and complete the registration process shown in steps 505 and 509.

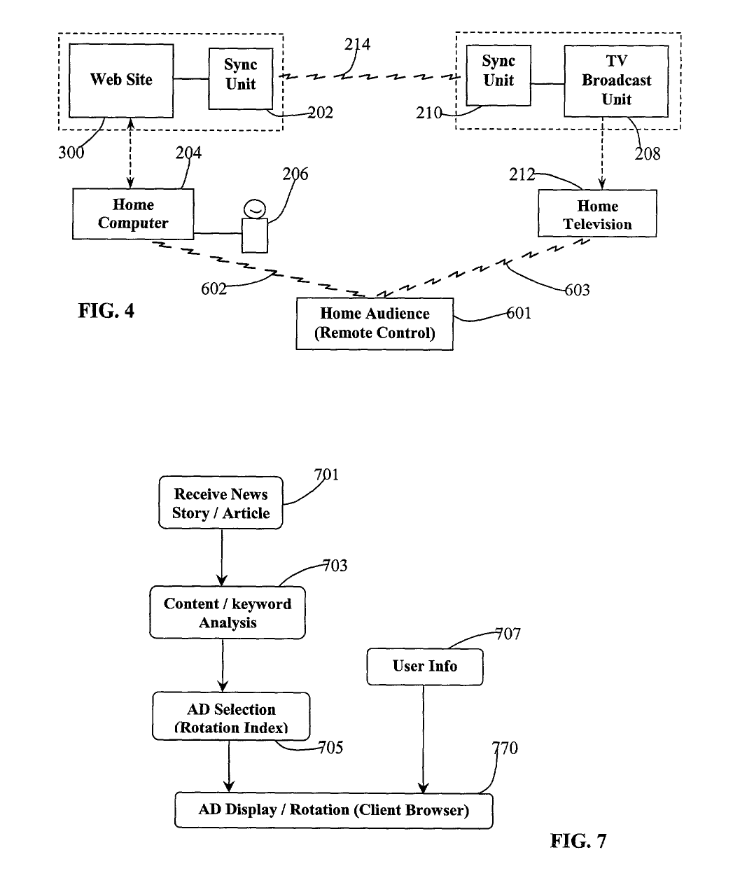

Referring now to FIGS. 4-6, there is shown synchronization methods and systems according to another aspect of the present inventions. In the ensuing description, the methods and systems of the present inventions are applied to synchronizing the transmission of Web contents/data received and/or displayed by a home user's Web browser with a TV program shown on said user's TV screen. However, one skilled in the art would understand that, said methods and systems of the present inventions may also be applied to synchronizing the transmission other type of multimedia and/or interactive communication systems.

As shown in FIG. 4, an interactive household computing and entertainment system includes, a conventional home television set 212 for receiving TV program signals from a TV station's broadcast unit 208, a home computer or a Web browser 204 for sending requests to and receiving information or data from a Web site 300 via the Internet, a computer-controlled device 206, such as a computer-controlled talking doll, connected to and controlled by the home computer 204, and a remote-control unit 601. It is understood that the Web site 300 of FIG. 4 is a designated Web site for providing Web contents and/or data streams in conjunction with the TV program provided by the TV channel or TV station 208. According the present inventions, there are two ways to have the Web contents/data received and/or displayed by the computer 204 being synchronized with the TV program shown on the TV 212. (1) The first method is to provide the Web site 300 and the corresponding TV broadcasting unit 208 with synchronization systems, i.e., the synchronization is performed at the server sides, as described in the ensuing sections. Said first method is referred to herein as “Server-Side Synchronization”. (2) The second method is to provide the computer 204 with hardware and software application system for receiving and responding to signals transmitted from the remote control unit 601 such that, when the home user uses the remote control 601 to switch TV channels, the Web site accessed by the computer 204 will also be switched concurrently. Said second method is referred to herein as “Client Remote-Control Synchronization”. It is preferred that both these two methods are employed to provide the best results and quality services to the home users.

As shown in FIG. 4, the Web site 300 is provided with a synchronization unit 202. The TV broadcasting unit 208 is provided with a synchronization unit 210. In order for the Web site 300 to send Web content or data to the client computer 204 in synchronization with the transmission of TV program signals from the TV station 208 to the home TV 212, there is provided synchronization signals 214 for transmitting between the two synchronization units 202 and 210. The synchronization signals 214 may be wireless signals or transmitted via physical wiring connections. The synchronization signals 214 may be transmitted, preferably, from the unit 210 to the unit 202, or vice versa, or it could be two way signals exchange between the two synchronization units 210 and 202. One purpose of providing the synchronization systems 202 and 210 is to control the transmission of electronic data or media stream 260 (FIG. 6) from the Web site 300 to a user's Web browser or computer 204 in synchronization with a TV program signal stream 270 being transmitted from the TV broadcast unit 208 to the user's home TV 212, or vice versa, as shown in FIG. 6. The idea is to divide the TV program into a stream of small segments based on the desired Web content or data stream to be received by the client user computer while broadcasting said TV program. This could be done at the production stage of said TV program. The segmentation information thereof can be stored in conjunction with and on the same storage media as the TV program itself. The function of the TV station synchronization system 210 is to retrieve said segmentation information and, in accordance therewith, send synchronization signals 214i to the synchronization system 202 of the Web site 300. The function of the Web site synchronization system 202 is to receive said synchronization signals 214i, and, in accordance therewith, instruct the server of the Web site 300 to send the desired data or media stream or Web content to the client 204. The Web site may employ the so-called “PUSH” technology to sent the desired content or data to the client 204. Certainly, any other commonly used technology may also be used therefore. The default page of the Web site 300 may also be programmed to automatically “refresh” the client Web browser 204 such that said desired content or data can be “pulled” to the client 204.

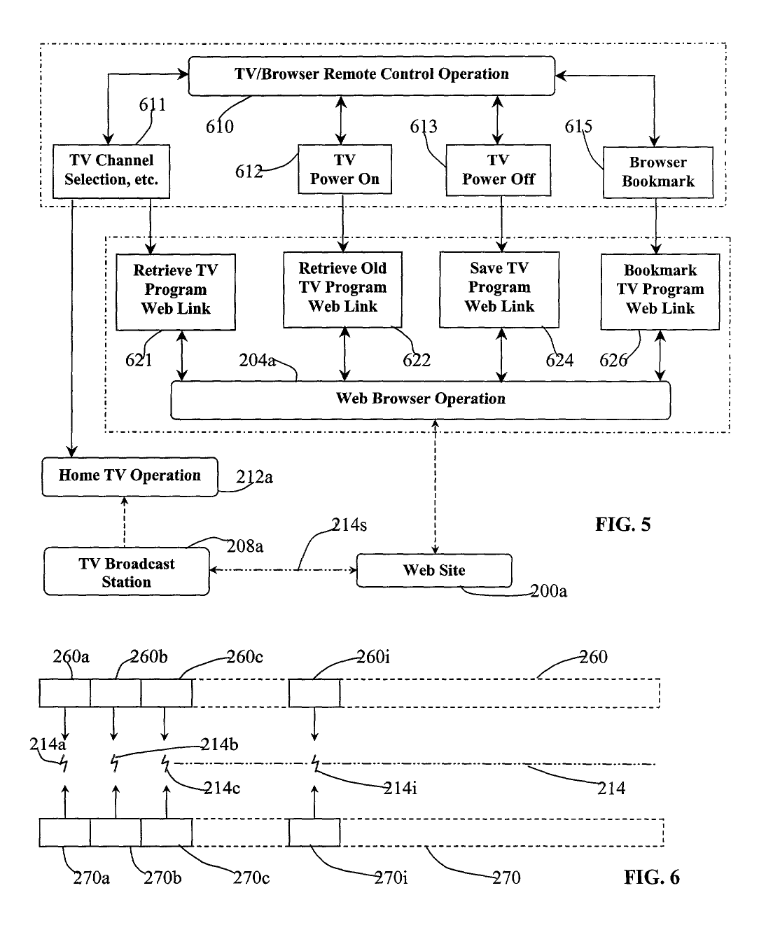

The “Server-Side Synchronization process of FIGS. 5-6 described above maybe used to only synchronize the starting moment of a electronic media/data stream 260 transmitted from the Web site 300 to the computer 204 with the starting moment of a TV program signals stream 270 transmitted from the TV station 208 to the home TV 212. However, it is preferred that the synchronization is conducted throughout the flow of said two data/signal streams. As shown in FIG. 6, the TV signal stream 270 of a TV program transmitted from the TV station 208 is divided into a stream of segments 270a, 270b, . . . , which are generally represented by the reference or segment number 270i; In conjunction and in accordance therewith, the electronic media or data stream 260 transmitted from the Web server 300 to the client 204 is divided into a stream of digital segments 260a, 260b, . . . , which are generally represented by the reference or segment number 260i. Each segment 270i of the TV signal stream 270 is associated with a specific segment 260i of the electronic media or data stream 260 such that, the transmission of the data stream segment 260i from the Web site 300 to the client computer 204 is to be synchronized with the broadcasting of the TV program segment 270i from the TV station 208. To facilitate such synchronization, a synchronization signal(s) 214i is provided for each segment pair 260i-270i of the two data-signal streams 260 and 270. For examples, as shown in FIG. 6, the first segment pair 260a-270a is provided with synchronization signal(s) 214a; the second segment pair 260b-270b is provided with synchronization signal(s) 214b; the third segment pair 260c-270c is provided with synchronization signal(s) 214c; etc.

The synchronization signals 214i are to be transmitted between the two synchronization systems 202 and 210 of FIG. 4. During a one-way synchronization process, the synchronization signals 214i are to be transmitted from the synchronization unit 210 of the TV station to the synchronization unit 202 of the Web site 300. When the synchronization system 202 receives the signals 214i, it will instruct the server of the Web site 300 to send the respective designated Web content or data stream segment 260i to the client computer 204. In this way, the server of the Web site 300 can control the timing of sending a specific segment 260i of the data or media stream 260 to a client in response to the synchronization system 202's receiving of the synchronization signals 214i from said TV station. Similarly, the synchronization system may also be designed to let the TV broadcast unit 208 controls the timing of broadcasting a specific segment 270i of the TV program 270 according to the synchronization system 210's receiving of the signals 214i from said Web site 300.

One skilled in the art would understand that, the above-described Server-Side Synchronization method may be used to synchronize the transmission of any type of Web contents or data stream from the Web site 300 to a client with the broadcasting of a TV program or a portion thereof from the TV station 208, and that there is no restriction or limit to the data type or the length of each segment 260i of the Web content or data stream 260. For examples, (1) the data stream or Web contents 260 of FIG. 6 may be a sequence of actuation control data for controlling the talking of the Internet enabled computer doll 206 of FIG. 4 through the computer 204; In this case, said synchronization would enable the doll 206 to interact with the TV program shown on the home TV 212; (2) The Web contents 260 of FIG. 6 may also be comprised of just a few Web pages in association with the TV program 270's specific section, such as an advertisement section for promoting a product; In this case, the TV station 208's synchronization system 210 will only send synchronization signals 214i to the Web site 300's synchronization system 202 while the TV station broadcasting said specific section of the TV program 270; As a result, when, for example, said product advertisement is shown on the home TV 212, the corresponding Web page for purchasing said product is immediately and automatically sent to and displayed by the computer Web browser 204; etc.

Referring now to FIG. 5 in conjunction with FIG. 4, there is shown the Client Remote-Control Synchronization methods and systems according to another aspect of the present inventions. As shown in FIGS. 4 and 5, the home computer and Web browser 204 is provided with hardware and software application system for receiving and responding to signals transmitted from the remote control unit 601, as described hereinbelow. When the home user uses the remote control 601 to switch TV channels, the wireless signals thereof will be received by both the home TV 212 and the home computer 204. In response thereto, the TV channel will be switched in a conventional manner, and in the meantime, the Web site accessed by the computer 204 will also be switched to the designated Web site of the new TV channel or program.

As shown in FIGS. 4-5, the remote-control unit 601 includes all the functionalities and push-buttons of a conventional TV/VCR remote control device, such as TV channel selection functions 611, TV power-on and power-off functions 612 and 613, and sound volume control functions (not shown), etc. It is preferred that the remote-control unit 601 is also provided with a new Web browser control function and press button, i.e., browser bookmark 615 for causing the Web browser 204 to bookmark a Web site or Web page, as described hereinbelow. The home TV 212's functionalities are the same as that of a conventional home TV, such, for example, as changing TV channel at step 212a in response to the remote-control 601's TV channel selection operation 611, and power-on/power-off (not shown in FIG. 5) in response to the remote control 601's TV power on 612 and TV power off 613 operations, etc. The following description will focus on the operation and functionality 204a of the home computer and Web browser 204 according to the present inventions.

In accordance with the present inventions, the home computer/Web browser 204 is provided with hardware and software systems to respond to the remote control unit 601's various operations, such as TV channel selection 611, power on 612, power-off 613, and browser bookmark 615, as shown in FIG. 5. When the home user uses the remote control unit 601 to switch TV channel at step 611, the wireless signals thereof will be received by the computer 204. In response thereto, the computer 204 will retrieve the IP address or URL or Web link of the new or current TV channel or program's designated Web site or Web page at step 621, and then access said Web site by sending a request thereto. Said IP address, URL or Web link may be saved in the computer 204's memory or storage system or in a remote Web site's database system or the like. As a result, when said home user uses the remote control unit 601 to switch to a new TV channel, the default Web page in association with the new TV channel or program selected will be displayed by the Web browser 204. When the home user uses the remote control unit 601 to turn off the TV power at step 613, the wireless signals thereof will cause the computer 204, at step 624, to save the current Web site or Web page's IP address or URL or Web link into the computer 204's storage or memory means such as the hard drive thereof. When the home user uses the remote control unit 601 to turn on the TV power at step 612, the wireless signals thereof will, at step 622, cause the computer 204 to retrieve the IP address or URL or Web link previously saved at step 624, and then access the Web site associated therewith, by sending a request thereto. As a result, when the TV 212 is turned on, the default Web page of the current TV program or TV channel is displayed by the Web browser 204. As described above, the remote control unit 601 includes a new bookmark function/button according to the present inventions. When the home user presses said bookmark button at step 615, the wireless signals thereof will, at step 626, cause the Web browser 204 to add the current Web page associated with the current TV program shown on the TV 212 to the Web browser's bookmark list if the TV power is turned on.

On skilled in the art would understand that, the remote control unit 601 and the home computer 204 may be provided with many other interaction functionalities or components such that the home user could have more options while using the remote control unit 601 to control the home computer 204, and that the Web browser bookmark described above include all the similar features of all type of Web browsers, such as the MS Internet Explorer's “Favorites” menu or list and the “Link” bar or the like, provided to facilitate a user's easy access to his/her favorite Web contents or documents, etc.

Reference is now made to FIG. 7. According to another aspect of the present inventions, in some circumstances, the selection of advertisement to be displayed on or with a Web page may be based on the text content of said Web page. This method is especially conductive for advertising on electronic news Web site. For examples, if an electronic news article on a Web page is related a technology company's breakthrough or innovation, the ad banner for promoting said technology company's new products should be selected for display on top or bottom of said Web page, etc. In order to facilitate the Web site's ad selection based the text content of a Web page, each advertising banner or Web page may be provided with a group of pre-selected keywords. For example, if an ad banner is for promoting a baseball related computer game made by a company named “XYZ”, then the keywords for this ad banner may include the words or phrases “baseball”, “computer game”, the company's name “XYZ”, and the company's Web site address, etc. During the ad selection process, the “weight” factors assigned to different keywords may be different. In the aforementioned example, the company's name “XYZ” may carry much more weight than the keyword “baseball”. Similarly, the Web site may also select certain keywords or embedded Web link addresses from the ASCII content of a Web page to determine which ad(s) are to be displayed with or rotated on said Web page.

FIG. 7 shows an exemplary ad selection process to be implemented on a Web site according to the present inventions. The process starts with the Web site receiving an electronic news article at step 701. The Web site will then perform article content and keyword analysis at step 703 for selecting a limited number of ads for display with or on the electronic news article Web page. For examples, the Web site could first determine, based on all the Web link addresses embedded in the electronic articles, which company's ad is to be displayed; the Web site may also evaluate what type of products or services are most related to said electronic news article. At the next step 705, after a limited number of advertising banners or Web pages have been selected, the Web site will assign an ad rotation index to each selected ad, based on the keywords associated with said selected ad, and/or on the text content of said electronic news article. The ad rotation index will determine when and for how long said selected ad will be displayed on or with said electronic news article Web page. Then at the final step 770, the Web site will cause the actual display or rotation of each selected ad on or with said electronic news article Web page based on said ad rotation index and/or on information 707 about each client if any.

Naturally, the embodiments of the present inventions are not limited to the above-described examples. While certain novel features of the inventions have been shown and described and are set out in the appended claims, it will be understood that various substitutions and changes in the forms and details of the embodiments described throughout this application and in their operation can be made by those skilled in the art without departing from the spirit of the inventions.

What is claimed is:

1. In an interactive home computing and entertainment system including a conventional home TV for presenting to a home user a plurality of TV programs provided over the respective TV channels, an Internet enabled computer having a Web browser, and a remote control means having the functions of a conventional TV/VCR remote control device, each said TV channel being provided with a designated Web site for providing a Web content in association with the TV program thereon, a computer-implemented method for receiving the Web content associated with the current TV program via the Internet in synchronization with the broadcasting of the current TV program, said method comprising the steps of:
in response to the transmission of a TV-operation signal from said remote control means for controlling said home TV, retrieving the Web site address of the current TV channel's designated Web site;
sending a request via the Internet to said current TV channel's Web site for requesting the Web content associated with the current TV program provided over said current TV channel; and
receiving the Web content associated with the current TV program from said current TV channel's designated Web site via the Internet.

2. The method as set forth in claim 1, wherein said TV-operation signal includes a TV channel selection signal transmitted from said remote control means for selecting a new TV channel.

3. The method as set forth in claim 1, wherein said TV-operation signal includes a TV power-on signal transmitted from said remote control means for turning on the TV power.

4. The method of claim 1, further comprising the step of storing the Web site address of the current Web content associated with the current TV program in said computer's data storage means in response to the transmission of a TV power-off signal from said remote control means for turning off the TV power.

5. The method as set forth in claim 4, wherein said TV-operation signal includes a TV power-on signal transmitted from said remote control means for turning on the TV power, and wherein said step of retrieving the Web site address includes retrieving the Web site address previously saved while the TV power being turned off.

6. The method of claim 1, further comprising the step of adding said Web content associated with the current TV program into said computer Web browser's bookmark list in response to the transmission of a bookmark signal from said remote control means.

7. The method of claim 1, wherein said Web content includes at least one Web page for providing information about said current TV program.

8. A method of transmitting a segment of Web content from a Web site to a client computer connected thereto via the Internet in synchronization with the broadcasting of a specific segment of a TV program from a TV broadcast system, said Web content being associated with said TV program, said segment of Web content being associated with said specific segment of the TV program, said method comprising the steps of:
Sending a synchronization signal from said TV broadcast system to said Web site while broadcasting said specific segment of the TV program;
In response to said Web site receiving said synchronization signal, sending said segment of Web content from said Web site to said client computer connected thereto via the Internet.

9. A method as set forth in claim 8, wherein said segment of Web content includes at least one Web page.

10. A method as set forth in claim 8, wherein said Web content includes a stream of actuation-control data for controlling the body part movement of an Internet-enabled talking doll controlled by said client computer, and wherein said segment of Web content includes a segment of said actuation-control data stream for controlling a specific movement of the body part of said Internet-enabled talking doll in synchronization with the broadcasting of said specific segment of the TV program.

11. A method as set forth in claim 10, wherein said Web site includes means for causing sequential transmission of said actuation-control data stream therefrom to said client computer connected thereto via the Internet.

12. A method of transmitting a segment of Web content from a Web site to a client computer connected thereto via the Internet in synchronization with the broadcasting of a specific segment of a TV program from a TV broadcast system, said Web content being associated with said TV program, said segment of Web content being associated with said specific segment of the TV program, said method comprising the steps of:
providing broadcast synchronization means to said TV broadcast system for sending a synchronization signal therefrom to said Web site while broadcasting said specific segment of the TV program;
providing Web site synchronization means to said Web site for instructing said Web site to send said segment of Web content to said client computer connected thereto via the Internet in response to said Web site receiving said synchronization signal.
